(19) United States
(12) Patent Application Publication
(10) Pub. No.: US 2014/0153517 A1
(43) Pub. Date: Jun. 5, 2014

(54) METHOD OF AND APPARATUS FOR PHYSICAL RANDOM ACCESS IN COMMUNICATION NETWORK

(71) Applicants: Yu Chen, Shanghai (CN); Jialin Zou, Randolph, NJ (US); Sudeep Palat, Swindon (GB)

(72) Inventors: Yu Chen, Shanghai (CN); Jialin Zou, Randolph, NJ (US); Sudeep Palat, Swindon (GB)

(73) Assignee: ALCATEL LUCENT, Paris (FR)

(21) Appl. No.: 14/128,125

(22) PCT Filed: Jul. 5, 2012
(86) PCT No.: PCT/IB2012/001571

§ 371 Date: Dec. 20, 2013

(30) Foreign Application Priority Data
Jul. 6, 2011 (CN) 201110188188.3

(51) Int. Cl. H04W 74/08

(52) U.S. Cl. CPC H04W 74/0833
USPC 370/329

(57) ABSTRACT

In an embodiment of the invention, there is proposed a method of and apparatus for accessing in a user equipment, the method including the steps of: i) performing a random access on a predetermined resource according to a channel condition of the user equipment, wherein the predetermined resource is associated with the channel condition of the user equipment; and ii) receiving, on a PDCCH, a response to the random access from an eNB. With this solution, during a random access of a user equipment, particularly a MTC device, an eNB can perform a Random Access Response (RAR) adaptively using a different number of Control Channel Elements (CCEs) according to an indication, capable of reflecting a channel condition, e.g., a signal to noise ratio, of the user equipment, thereby saving the channel resource.

### FIELD OF THE INVENTION

The present disclosure relates to the field of wireless communications and particularly to a method of and apparatus for a physical random access in a wireless communication network.

### BACKGROUND OF THE INVENTION

Along with the development of internet technologies, the concept of an internet of things has gradually become an important constituting part of a new generation of information technologies. A network similar to an internet of things has two features: firstly, its core and foundation are still a communication network, for example, the mobile Internet, i.e., a network resulting from an extension and an expansion of the Internet; and secondly, its user terminals are extended and expanded to those suitable for information exchange and communication between any objects instead of being limited to the traditional user equipments which are suitable for information exchange and communication between humans.

At present and in the future, terminals belonging to the majority of networks similar to an internet of things, referred to as Machine Type Communication (MTC) devices, will communicate using the existing mobile Internet as a carrier. Thus the steps of connection accessing, communicating, etc., for a session or communication of the MTC device generally have to be performed in coexistence with a traditional Human to Human (H2H) type User Equipment (simply referred to as a UE in the following). Correspondingly the MTC device and the UE may also be in the same network and process the same signaling concurrently in the same way, which may result in a considerable occupancy and consumption of existing channel resources during the communication procedure.

### SUMMARY OF THE INVENTION

In the 3GPP study item of MTC, namely machine type communication, the RAN overload control is very important. After study, the inventors have discovered that the during the surge of MTC devices access, where the amount of MTC devices is often one or two orders of magnitude larger than that of the normal UEs, the signaling resource becomes a bottleneck. In a communication phase of a Physical Random Access Channel (PRACH), there are two messages that need to be indicated before user plane data is transmitted/received, i.e., the message 2 for a random access response and the message 4 for setting up a Radio Resource Control (RRC) connection. The resource needed to transmit one physical layer PDCCH signaling depends on its channel condition. At the beginning of an access, the channel condition of a MTC device is not known by the eNodeB (eNB), because there is no channel measurement report available yet. Thus when the message 2, i.e., a random access response message is transmitted, the eNB has to assume that the UE may be located at the cell edge, so by default this message needs to use more resources, for example, possibly always 8 CCEs as shown in Table 1 below. It is assumed by the 3GPP that there are 16 CCEs in total available for a 5M Bandwidth (BW), so the RAR message consumes half of the signaling resource. This problem of excessive resource consumption has to be solved. As can be seen from Table 1 below, the resource consumption is doubled for the format 3 as compared to the format 2. Thus it is feasible to make full use of the PDCCH format in terms of saving the signaling resource.

TABLE 1
PDCCH formats supported by 3GPP 36.211

| PDCCH | Number of | Number of | Number of |
|---|---|---|---|
| format | CCEs | resource-element groups | PDCCH bits |
| 0 | 1 | 9 | 72 |
| 1 | 2 | 18 | 144 |
| 2 | 4 | 36 | 288 |
| 3 | 8 | 72 | 576 |

In view of the drawback in the prior art, it is advantageous for the use of the resource during the radio access to propose a method of and apparatus for a physical random access for a radio network, so that the channel resource can be selected adaptively according to a channel condition during a random access of a UE to an eNB, so as to save Control Channel Elements (CCEs).

Correspondingly according to an embodiment of the invention, there is proposed a method of accessing in a user equipment. The method comprises the steps of: i) performing a random access on a predetermined resource according to a channel condition of the user equipment, wherein the predetermined resource is associated with the channel condition of the user equipment; and ii) receiving, on a PDCCH, a response to the random access from an eNB.

Optionally if an error occurs with decoding the PDCCH in the step of receiving the response, then after the step of receiving the response, the method further includes the step of: performing a random access on a second predetermined resource, wherein a channel condition associated with the second predetermined resource is poorer than the channel condition of the user equipment. Of course, if an error occurs again with decoding the PDCCH, then another predetermined resource can be selected again to perform the random access. The procedure will be repeated until an access succeeds on the selected resource.

According to another embodiment of the invention, there is proposed a method, in an eNB, of responding to an access of a user equipment. The method comprises the steps of: i) determining a predetermined resource used by the user equipment according to a random access of the user equipment; and ii) responding to the random access of the user equipment in a PDCCH format associated with the predetermined resource.

According to an embodiment of the invention, there is proposed an apparatus for accessing in a user equipment. The apparatus comprises: a random access device for performing a random access on a predetermined resource according to a channel condition of the user equipment, wherein the predetermined resource is associated with the channel condition of the user equipment; and a response receiving device for receiving, on a PDCCH, a response to the random access from an eNB.

According to an embodiment of the invention, there is proposed an apparatus, in an eNB, for responding to an access of a user equipment. The apparatus comprises: a resource determining device for determining a predetermined resource used by the user equipment according to a random access of the user equipment; and an access responding device for responding to the random access of the user equipment in a PDCCH format associated with the predetermined resource.

Optionally the channel condition in the method or apparatus above is a Signal to Noise Ratio (SNR).

Optionally the predetermined resource in the method or apparatus above may be time resource or frequency resource of a random access occasion.

With the foregoing solutions, at the side of the user equipment, a channel condition of the user equipment is associated with some predetermined resources for a random access and the eNB will be informed during Random Access Channel (RACH) communication. At the side of the eNB, the predetermined resource is associated with a resource used for a PDCCH responding to the random access of the UE, i.e., a PDCCH format. Thus the eNB can respond to the random access of the UE in the corresponding PDCCH format according to the predetermined resource used for the access of the UE. Stated otherwise, the eNB can obtain channel quality information of the UE, e.g., an SNR, at the beginning of the PRACH process and respond to the random access of the UE adaptively in a different number of Control Channel Elements (CCEs), thereby saving a channel resource.

### BRIEF DESCRIPTION OF DRAWINGS

The foregoing and other features of the invention will become more apparent from the following detailed description of the embodiments illustrated with reference to the drawings in which identical reference numerals denote identical or similar elements. In the drawings:

FIG. 1 illustrates a physical location relationship between a UE and an eNB applicable to a method or apparatus according to some embodiments of the invention;

FIG. 2 illustrates a flow chart of a method of accessing according to an embodiment of the invention;

FIG. 3 illustrates a flow chart of a method of responding to an access of a user equipment according to an embodiment of the invention;

FIG. 4 illustrates an allocation diagram of predetermined timeslot resource applicable during an RACH access process according to some embodiments of the invention;

FIG. 5 illustrates an allocation diagram of predetermined frequency resource applicable during an RACH access process according to some embodiments of the invention;

FIG. 6 illustrates a structural diagram of an apparatus for accessing according to an embodiment of the invention; and

FIG. 7 illustrates a structural diagram of an apparatus for responding to an access of a user equipment according to an embodiment of the invention.

### DETAILED DESCRIPTION OF EMBODIMENTS

Study shows that one important feature of Machine to Machine (M2M) communication is that the locations of related devices are substantially fixed. The majority of currently foreseeable popular applications of an internet of things (Machine Type Communication (MTC)) are smart meters, where the devices are substantially fixed indoors. Thus generally, the channel condition between the device and the eNB is also substantially fixed, since the physical location of the device is substantially fixed. Due to this feature of low mobility, the accessing parameter can be optimized correspondingly. The basic idea is to indicate the substantially fixed channel conditions of the related MTC devices to the eNB, so that the eNB can use the specific PDCCH format with less resource usage. The configuration could be based on a path loss or simply based on the distances to the eNB. The PDCCH is received by blind decoding, so there is no problem in receiving any PDCCH format.

Message 2 Being Bottleneck During MTC Access

During a contention based access, the message 2 and the message 4 transmitted from an eNB to a UE need PDCCHs to indicate the transmission. Especially for the message 2, it is difficult for the eNB to estimate a channel condition according to a RACH preamble. During the access, each UE starts with low transmit power, and the transmit power gradually ramps up if there is no response from the eNB. Thus the eNB can detect the preambles after several attempts. Hence this normally means that the SNR received by each UE is the same or similar regardless of its location, because a UE at a longer distance will ramp up its power for more times. Such a mechanism is important for controlling interference to another cell. The eNB has to use the one that can satisfy the worst channel condition. For the eNB, the total amount of resources available for the transmission of a PDCCH is fixed, so a reduced number of PDCCHs can be supported in general if an excessive resource is used for the PDCCH of one UE.

A PDCCH is used to transmit a resource grant, Random Access Response (RAR) message indication information and other signaling. If the eNB can not find sufficient PDCCH resources to transmit Random Access-Radio network Temporary Identifier (RA-RNTI) indications, then some RAR messages can not be transmitted in time. Table 2 below shows an impact of the average number of RAR messages on the access success rate. Thus if there are more PDCCH resources available, then MTC devices and normal UEs will benefit therefrom.

TABLE 2
MTC access success rate

| | 3 UL grants | 2 UL grants |
|---|---|---|
| Access success rate | 89.98% | 41.5% |

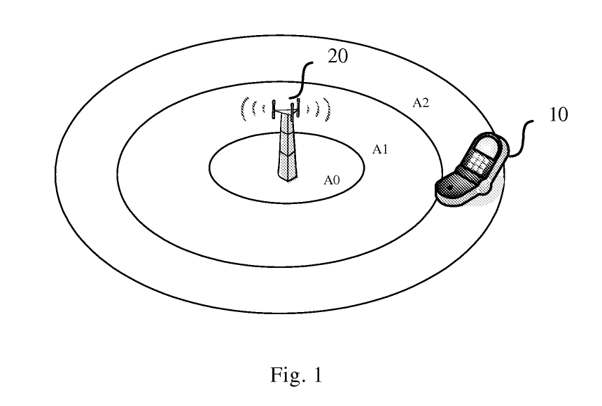

In view of the foregoing analysis of the use of the predetermined resource, e.g., a preamble resource used during a random access, embodiments of the invention will be detailed below with reference to FIG. 1 to FIG. 5.

FIG. 1 illustrates a physical location relationship between a UE 10 and an eNB 20 applicable to a method or apparatus according to some embodiments of the invention, wherein the UE 10 is a MTC device. Since generally the channel condition between the UE 10 and the eNB 20 will be poorer, if the UE 10 is located in an area A2 at a longer distance to the eNB 20, then; while the channel condition between the UE 10 and the eNB 20 will be at a moderate level, if the UE 10 is located in an area A1 at a moderate distance to the eNB 20; and the channel condition between the UE 10 and the eNB 20 will be better, if the UE 10 is located in an area A0 at a shorter distance to the eNB 20.

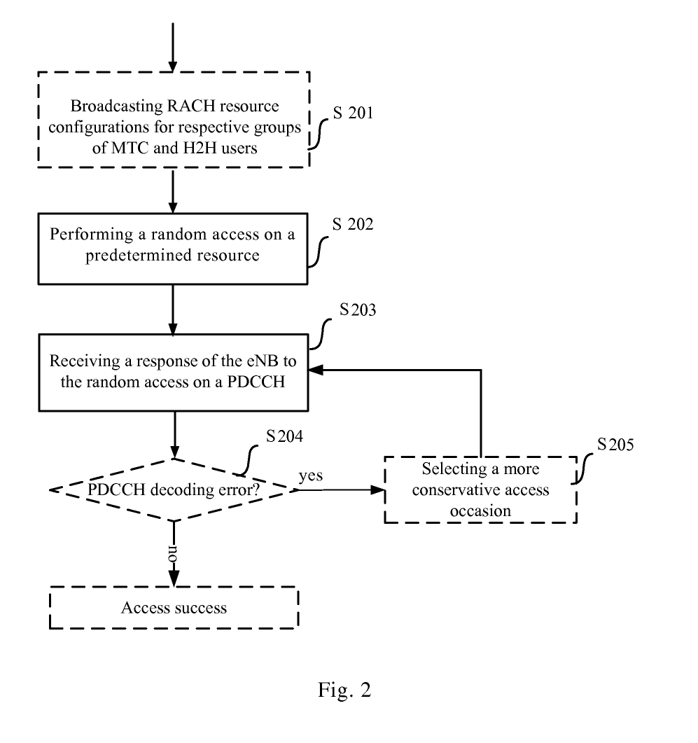

FIG. 2 illustrates a flow chart of a method of accessing according to an embodiment of the invention. The method generally comprises the step S202 of performing a random access and the step S203 of receiving a response.

In the step S202, the UE 10 performs a random access on a predetermined resource according to a channel condition of the user equipment, wherein the predetermined resource, e.g., a preamble resource used for the access, is associated with the channel condition of the UE 10.

Then the UE 10 receives, on a PDCCH, a response to the random access from the eNB 20.

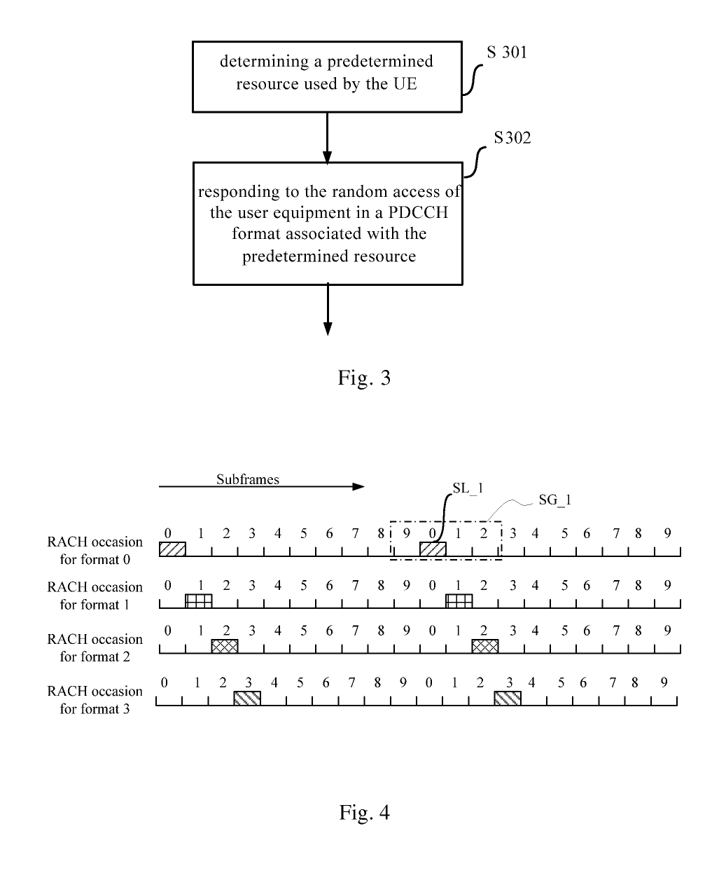

FIG. 3 illustrates a flow chart of a method of responding to an access of a user equipment according to an embodiment of the invention. The method comprises the step S301 of determining a predetermined resource and the step S302 of responding to a random access.

In the step S301, the eNB 20 determines a predetermined resource used by the UE 10 according to a random access of the user equipment.

In the step S302, the eNB 20 responds to the random access of the user equipment in a PDCCH format associated with the predetermined resource.

Preamble Planning Scheme

As shown above in Table 1, there are four PDCCH formats available in a cell.

FIG. 4 illustrates an allocation diagram of predetermined timeslot resource applicable during an RACH access process according to some embodiments of the invention, wherein time-domain RACH occasions for the foregoing PDCCH format 0 to PDCCH format 3 are schematically illustrated in the time domain respectively.

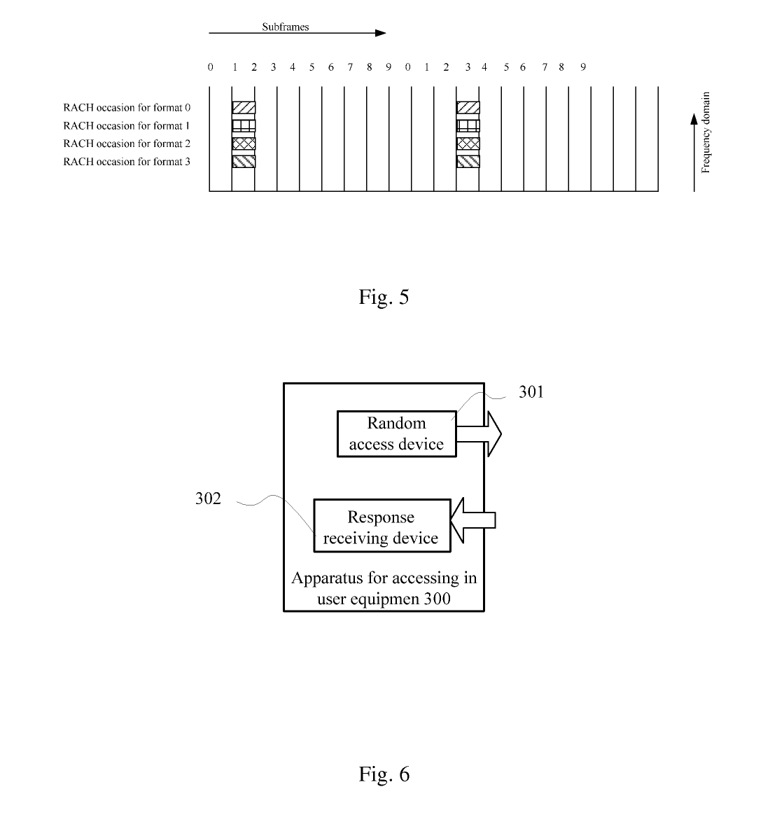

FIG. 5 illustrates an allocation diagram of predetermined frequency resource applicable during an RACH access process according to some embodiments of the invention, wherein frequency-domain RACH occasions for the foregoing PDCCH format 0 to PDCCH format 3 are schematically illustrated in the frequency domain respectively.

Optionally the time resource is a configuration index, and the channel condition is a signal to noise ratio.

In view of the foregoing analysis of the relationship between a geographical location and a channel condition, a PDCCH format can be selected for a specific UE under a principle determined by its location in some foregoing embodiments of the invention. Of course, the foregoing embodiments of the invention can alternatively be implemented only according to the channel condition, which changes not much for static terminals, such as MTC, etc. Thus three MTC groups can be defined for the three areas A0, A1 and A2 in FIG. 1. The three MTC groups respectively correspond to three different channel conditions, for example, with a signal to noise ratio of [−5 dB, +3 dB], [−10 dB, −5 dB] and [−20 dB, −10 dB] respectively.

Optionally the step S202 of performing a random access can further comprise the step of: performing the random access on a first configuration index, e.g., a preamble location, associated with a first interval of values, if the signal to noise ratio lies in the first interval of values. The UE 10 in the area A2 detects its signal to noise ratio of −15 dB during the random access, which belongs to the signal to noise ratio range of [−20 dB, −10 dB]. It is assumed that the foregoing three signal to noise ratio ranges of [−5 dB, +3 dB], [−10 dB, −5 dB] and [−20 dB, −10 dB] are associated respectively with configuration indexes corresponding to three RACH occasions, i.e., a “RACH occasion for the format 0”, a “RACH occasion for the format 1” and a “RACH occasion for the format 2”. That is, a preamble resource associated with the signal to noise ratio range of [−20 dB, −10 dB] corresponding to the UE 10 is preset as the “RACH occasion of the format 2” as illustrated in FIG. 4. Thus in the step S202, the UE 10 can choose to perform the access on the RACH occasion for the format 2, for example, to transmit the message 1, etc.

Of course, although the UE 10 is located in the area A2, in some cases, the signal to noise ratio of the UE 10 may also belong to the range of [−10 dB, −5 dB]. Thus the UE 10 may choose to perform the access on the RACH occasion for the format 1 according to the foregoing predetermined association between the signal to noise ratio ranges of the UE 10 and the preamble resources.

Next correspondingly the step S301 can further include the step of “responding to the random access of the user equipment in a PDCCH format associated with a first configuration index, if the user equipment performs the access on the predetermined first configuration index”. For example, the eNB 20 determines that the predetermined resource used by the UE 10 is the “RACH occasion for the format 2” and the configuration index thereof according to the random access behavior of the UE 10. It is assumed that the three configuration indexes represented by the “RACH occasion for the format 0”, the “RACH occasion for the format 1” and the “RACH occasion for the format 2” are associated respectively with the “PDCCH format 0”, the “PDCCH format 1” and the “PDCCH format 2” in Table 1. Therefore the PDCCH format associated with the predetermined resource for the access of the UE 10 is the third item of “PDCCH format 2” in Table 1. Thus in the step S301, the eNB 20 responds to the random access of the user equipment 10 in the “PDCCH format 2”.

Thereafter the UE 10 receives, on the PDCCH, the response to the random access of the UE 10 in the “PDCCH format 2” from the eNB 20.

In the foregoing embodiment, for a user equipment in the area A2, e.g., the UE 10, the eNB 20 can respond to the random access of the UE in the PDCCH format 2; for user equipments in the areas A0 and A1 (not illustrated), the eNB 20 can respond to the random accesses of the corresponding UEs respectively in the PDCCH format 0 and the PDCCH format 1; for a user equipment outside the area A2 at a longer distance to the eNB 20 (not illustrated), the eNB 20 can respond to the random access of the corresponding UE in the PDCCH format 3; and so on. With this solution, the eNB 20 can obtain the signal to noise ratio of the UE 10 indirectly, so that the eNB 20 can adaptively respond to the access of the UE 10 on an appropriate PDCCH resource according to the channel quality of the accessing UE. Thus more available CCE resources can be saved to respond to an access of another UE or to schedule another UE.

Technically, the eNB can use different RACH occasions to distinguish a normal UE from a MTC device or between MTC devices at different geographical locations to some extent during the random access in the foregoing embodiment.

Of course optionally, the predetermined resource can be time resource illustrated in FIG. 4 or frequency resource illustrated in FIG. 5.

It shall be noted that the scenario where the user equipment UE 10 is a MTC device has been described in the foregoing embodiment. In fact the method according to this embodiment can also be applicable to a normal H2H user equipment in some application scenarios, for example, some home handheld mobile phones with a long term unchanged geographical location. Of course, additional resources for MTC access can be multiplexed by time or frequency, while performing the foregoing method on a MTC device. It shall be noted that here the foregoing method can be performed on a MTC device while the signaling and resource allocation for H2H-type UEs remains the same as that in the prior art for compatibility. That is, for each RACH occasion, all the preamble can be used by an H2H-type UE.

Here optionally the UE 10 will alternatively select a different access timeslot and perform the access again when the UE 10 receives no RAR message. For example, the method according to the embodiment illustrated in FIG. 2 can further include the step S204 of decoding and determining and the step S205 of performing the access again. In the step S204, if an error occurs with decoding the PDCCH in the step S203 of receiving the response, then a random access is performed on a second predetermined resource in the step S205 of the method according to this embodiment, wherein a channel condition associated with the second predetermined resource, e.g., [−30 dB, −20 dB], is poorer than the channel condition [−20 dB, −10 dB] of the user equipment. Then at the side of the eNB 20, the eNB 20 can use a more conservative access occasion and select more CCE resources according to the configured association to set up a PDCCH channel for responding to the UE 10. This procedure will be repeated until the eNB responds to the random access of the UE 10 on the most available PDCCH resources, i.e., in the PDCCH format 3.

Optionally before the step S202 of performing the random access, the method according to the foregoing embodiment further comprises the step of allocating the random access to a first set of timeslots according to a predetermined probability. The first set of timeslots includes a plurality of timeslots as indicated by the set of timeslots SG_1 in FIG. 4, and preferably the set is defined/configured to be constituted of consecutive timeslots.

For example, the predetermined probability can be derived from a modulo operation of an international mobile subscriber identity code of the UE 10 modulo 2^{N}, e.g., 512, wherein N is a positive integer. Stated otherwise, the international mobile subscriber identity code of the UE 10 is modulo-divided by “512” so that the UE 10 corresponds to, for example, the RACH occasion SL_1 with a probability of “1/512”. The occasion SL_1 belongs to the set of timeslots SG_1, and then the access of the UE 10 will be allocated into the set of timeslots SG_1, that is, the UE 10 is allocated into or corresponds to the set of timeslots SG_1 with a probability of “4/512”. In this approach of allocating a probability of access traffic of the user equipment, the access traffic can be decentralized and a communication load of the system can be reduced. Meanwhile, the signal to noise ratio ranges of [−30 dB, −20 dB], [−20 dB, −10 dB], [−5 dB, +3 dB] and [−10 dB, −5 dB] are associated respectively with configuration indexes at the locations of the digits “9”, “0”, “1” and “2” in the set of timeslots SG_1. If the UE 10 detects its signal to noise ratio of 0 dB which belongs to the range of [−5 dB, +3 dB], then the UE 10 correspondingly performs the random access on the predetermined resource belonging to the first set of timeslots SG_1, i.e., the RACH occasion at the location of the digit “1” in the set of timeslots SG_1 in the step S202 of performing the random access.

At the side of the eNB 20, the associated PDCCH format is determined according to the location of the predetermined resource in the first set of timeslots where it is located in the step S302. For example, it is assumed that the RACH occasions or the configuration indexes at the locations of the digits “9”, “0”, “1” and “2” in the set of timeslots SG_1 are associated respectively with the “PDCCH format 3”, the “PDCCH format 2”, the “PDCCH format 1” and the “PDCCH format 0” in Table 1. Then since it is determined in the step S301 that the RACH occasion used by the UE 10 corresponds to the configuration index at the location of the digit “1” in the set of timeslots SG_1, the eNB 20 responds to the random access of the UE 10 in the “PDCCH format 1” associated with the configuration index of the predetermined resource at the location of the digit “1”.

In the foregoing some embodiments, some configurations and desired signaling can further be provided so that the eNB knows how may CCEs are required for a specific MTC device to transmit a message and the UE knows the foregoing various association information. For example, before the step S301, the eNB 20 can further transmit a first broadcast message to the UE 10 indicating an association between the channel condition of the user equipment 10, e.g., the signal to noise ratio, and the predetermined resource that shall be used for the UE 10 during the RACH access. Of course those skilled in the art shall appreciate that if the UE 10 is not notified of the association in the foregoing first broadcast message, then by using some preset “system configurations” the UE 10 alternatively obtains the foregoing association information from the “system configuration”, for example, when the UE is powered on, and a repeated description of these alternatives will be omitted here.

Correspondingly at the side of the UE 10, before the step S202 of performing the random access, the method can further comprise the step of receiving a first broadcast message, from the eNB 20, indicating an association between the channel condition and the predetermined resource that shall be used for the UE during the RACH access.

FIG. 6 illustrates a structural diagram of an apparatus for accessing according to an embodiment of the invention. The apparatus 300 generally can be configured in a user equipment, e.g., the UE 10, and the apparatus 300 comprises a random access device 301 and a response receiving device 302.

The random access device 301 is configured to perform a random access on a predetermined resource according to a channel condition of the user equipment, wherein the predetermined resource is associated with the channel condition.

The response receiving device 302 is configured to receive, on a PDCCH, a response to the random access from an eNB.

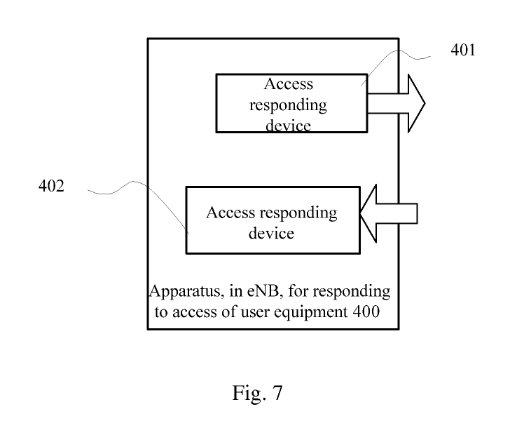

FIG. 7 illustrates a structural diagram of an apparatus for responding an access of a user equipment according to an embodiment of the invention. The apparatus 400 generally can be configured in an eNB, e.g., the eNB 20. The apparatus comprises a resource determining device 401 and an access responding device 402.

The resource determining device 401 is configured to determine a predetermined resource used by the user equipment according to a random access of the user equipment

The access responding device 402 is configured to respond to the random access of the user equipment in a PDCCH format associated with the predetermined resource.

Optionally the apparatus 400 further comprises a broadcast message transmitting device configured to transmit to the user equipment a first broadcast message indicating an association between a channel condition of the user equipment and the predetermined resource.

Optionally the channel condition in the foregoing embodiments is a signal to noise ratio.

Furthermore the embodiments of the invention can be implemented in software, in hardware or in a combination of software and hardware. A part in hardware can be implemented in a dedicated logic, and a part in software can be stored in a memory and executed by an appropriate instruction execution system, e.g., a microprocessor or specially designed hardware. Those ordinarily skilled in the art can appreciate the foregoing method and system can be implemented through using computer executable instructions and/or being included in control codes of a processor, where such codes are provided on a carrier medium, e.g., a disk, a CD or a DVD-ROM, a programmable memory, e.g., a Read Only Memory (firmware), or a data carrier, e.g., an optical or electronic signal carrier. The system and the components thereof according to the embodiments can be implemented in a hardware circuit, e.g., a very large scale integrated circuit or a gate array, a semiconductor (e.g., a logic chip, a transistor, etc.) or a programmable hardware device (e.g., a field programmable gate array, a programmable logic device, etc.), in software executed by various types of processors or in a combination of the foregoing hardware circuit and software.

Although the invention has been described with reference to the currently conceived embodiments, it shall be appreciated that the invention will not be limited to the disclosed embodiments. On the contrary, the invention is intended to encompass various modifications and equivalent arrangements falling into the spirit and scope of the appended claims. The scope of the appended claims shall be appreciated in the broadcast sense so as to encompass all these modifications and equivalent arrangements.

1. A method of accessing, in a user equipment, the method comprising:
performing a random access on a predetermined resource according to a channel condition of the user equipment, wherein the predetermined resource is associated with the channel condition of the user equipment; and
receiving, on a PDCCH, a response to the random access from an eNB.

2. The method according to claim 1, wherein if an error occurs with decoding the PDCCH in receiving the response, then after receiving the response, the method further comprises:
performing a random access on a second predetermined resource, wherein a channel condition associated with the second predetermined resource is poorer than the channel condition of the user equipment.

3. The method according to claim 1, wherein the predetermined resource is time resource or frequency resource of a random access occasion.

4. The method according to claim 1, wherein before performing the random access, the method further comprises:
allocating the random access to a first set of timeslots according to a predetermined probability; and
performing the random access further comprises:
performing the random access on the predetermined resource belonging to the first set of timeslots.

5. The method according to claim 4, wherein the predetermined probability is derived via a modulo operation of an international mobile subscriber identity code of the user equipment modulo 2^{N}, wherein N is a positive integer.

6. The method according to claim 1, wherein before the step of performing the random access, the method further comprises:
receiving a first broadcast message, from the eNB, indicating an association between the channel condition and the predetermined resource.

7. The method according to claim 3, wherein the time resource is a configuration index, the channel condition is a signal to noise ratio; and performing the random access further comprises:
performing the random access on a first configuration index associated with a first interval of values, if the signal to noise ratio lies in the first interval of values.

8. A method, in an eNB, of responding to an access of a user equipment, the method comprising:
determining a predetermined resource used by the user equipment according to a random access of the user equipment; and
responding to the random access of the user equipment in a PDCCH format associated with the predetermined resource.

9. The method according to claim 8, wherein the predetermined resource is time resource or frequency resource of a random access occasion.

10. The method according to claim 8, wherein responding to the random access further comprises:
determining the associated PDCCH format according to a location of the predetermined resource in a first set of timeslots where the predetermined resource is located.

11. The method according to claim 8, wherein before determining the predetermined resource, the method further comprises:
transmitting to the user equipment a first broadcast message indicating an association between a channel condition of the user equipment and the predetermined resource.

12. The method according to claim 9, wherein the time resource is a configuration index, and responding to the random access further comprises:
responding to the random access of the user equipment in a PDCCH format associated with a first configuration index, if the user equipment performs the access on the predetermined first configuration index.

13. An apparatus for accessing, in a user equipment, the apparatus comprising:
a random access device for performing a random access on a predetermined resource according to a channel condition of the user equipment, wherein the predetermined resource is associated with the channel condition of the user equipment; and
a response receiving device for receiving, on a PDCCH, a response to the random access from an eNB.

14. The apparatus according to claim 13, wherein the channel condition is a signal to noise ratio.

15. An apparatus, in an eNB, for responding to an access of a user equipment, the apparatus comprising:
a resource determining device for determining a predetermined resource used by the user equipment according to a random access of the user equipment; and
an access responding device for responding to the random access of the user equipment in a PDCCH format associated with the predetermined resource.

16. The apparatus according to claim 15, further comprising:
a broadcast message transmitting device for transmitting to the user equipment a first broadcast message indicating an association between a channel condition of the user equipment and the predetermined resource.
